(19) United States
(12) Patent Application Publication
(10) Pub. No.: US 2015/0035743 A1
(43) Pub. Date: Feb. 5, 2015

(54) Wrist Worn Platform for Sensors

(71) Applicant: Plantronics, Inc., Santa Cruz, CA (US)

(72) Inventor: Douglas K. Rosener, Santa Cruz, CA (US)

(73) Assignee: Plantronics, Inc., Santa Cruz, CA (US)

(21) Appl. No.: 13/956,004

(22) Filed: Jul. 31, 2013

(51) Int. Cl. G06F 3/033

(52) U.S. Cl. CPC G06F 3/033; G06F 2203/0331
USPC 345/156

(57) ABSTRACT

Methods and apparatuses for sensors are disclosed. In one example, a sensor system includes a wrist worn apparatus and a plurality of sensors. The wrist worn apparatus includes a communications interface, a user interface, a processor, and a memory including an application to receive a sensor data. The plurality of sensors are configured to send sensor data to the wrist worn apparatus. In one example, each sensor of the plurality of sensors is configured to be worn on a user finger.

### BACKGROUND OF THE INVENTION

The use of electronic sensors has increased recently. Furthermore, the use of mobile computing devices such as smartphones, tablet computers, and notebook computers has increased as well. These devices have improved significantly with respect to mobility, processing power and wireless communication capabilities.

Sensors can provide useful information in a variety of contexts and applications. For example, motion sensors can provide information which can be used to interpret human movement as a gesture. However, in the prior art, hand held devices have typically used motion sensors in limited applications, including only single sensor applications. In other cases, motion sensors are not worn or carried by a user at all, but operate at fixed locations, thereby limiting their usefulness.

As a result, improved methods and apparatuses for sensors are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a system for receiving sensor data at a wrist worn sensor hub in one example.

FIG. 2 illustrates a system for utilizing sensor data received at a wrist worn sensor hub in one example.

FIG. 3 illustrates a system for utilizing sensor data received at a wrist worn sensor hub in a further example.

FIG. 4 illustrates a simplified block diagram of the wrist worn sensor hub shown in FIG. 1 in one example.

FIG. 5 illustrates a simplified block diagram of the wrist worn sensor hub shown in FIG. 1 in a further example.

FIG. 6 illustrates the wrist worn sensor hub shown in FIG. 1 worn on a user wrist.

FIG. 7 illustrates the wrist worn sensor hub shown in FIG. 1 with a plurality of motion sensors coupled to the wrist worn sensor hub using a wired interface.

FIG. 8 is a flow diagram illustrating receiving sensor data received at a wrist-worn apparatus in one example.

FIG. 9 is a flow diagram illustrating utilizing sensor data received at a wrist-worn apparatus in one example.

FIG. 10 is a flow diagram illustrating utilizing sensor data received at a wrist-worn apparatus in a further example.

### DESCRIPTION OF SPECIFIC EMBODIMENTS

Methods and apparatuses for sensors are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein.

Block diagrams of example systems are illustrated and described for purposes of explanation. The functionality that is described as being performed by a single system component may be performed by multiple components. Similarly, a single component may be configured to perform functionality that is described as being performed by multiple components. For purpose of clarity, details relating to technical material that is known in the technical fields related to the invention have not been described in detail so as not to unnecessarily obscure the present invention. It is to be understood that various example of the invention, although different, are not necessarily mutually exclusive. Thus, a particular feature, characteristic, or structure described in one example embodiment may be included within other embodiments unless otherwise noted.

In one example, a sensor system includes a wrist worn apparatus and a plurality of sensors. The wrist worn apparatus includes a communications interface, a user interface, a processor, and a memory including an application to receive a sensor data. The plurality of sensors are configured to send sensor data to the wrist worn apparatus. In one example, each sensor of the plurality of sensors is configured to be worn on a user finger.

In one example, a method includes receiving a sensor data at a wrist worn apparatus associated one or more user fingers, and transmitting the sensor data to a computing device. The method includes processing the sensor data at the computing device to identify a user action, and performing an action at an application executing on the computing device responsive to the user action.

In one example, a method includes receiving a first sensor data at a wrist worn apparatus associated with one or more wireless sensors. The method further includes receiving a second sensor data at a wrist worn apparatus associated with one or more wired sensors coupled to the wrist worn apparatus via a wired interface, and receiving a third sensor data at a wrist worn apparatus associated with one or more sensors disposed on the wrist worn apparatus.

In one example, a sensor system includes a wrist worn apparatus. The wrist worn apparatus includes a wireless communications interface, a wired communications interface, a plurality of sensors, a user interface, and a processor. The wrist worn apparatus also includes a memory including an application to receive a sensor data. The sensor system includes a plurality of motion sensors coupled to the wired communications interface, where each motion sensor of the plurality of motion sensors is configured to be worn on a user finger.

In one example, a wrist worn sensor hub includes a wireless communications interface configured to receive a first sensor data from one or more wireless sensors and a wired communications interface configured to receive a second sensor data from one or more wired sensors. The wrist worn sensor hub includes one or more onboard sensors disposed on the wrist worn sensor hub configured to output a third sensor data. The wrist worn sensor hub further includes a user interface, a processor, and a memory including an application to receive the first sensor data, the second sensor data, and the third sensor data.

In one example, one or more non-transitory computer-readable storage media have computer-executable instructions stored thereon which, when executed by one or more computers, cause the one more computers to perform operations including receiving a motion sensor data at a wrist worn apparatus associated with movement of one or more user fingers, and transmitting the motion sensor data to a computing device. The operations further include processing the motion sensor data at the computing device to identify a user action, and performing an action at an application executing on the computing device responsive to the user action.

In one example, one or more non-transitory computer-readable storage media have computer-executable instructions stored thereon which, when executed by one or more computers, cause the one more computers to perform operations including receiving a first sensor data at a wrist worn apparatus associated with one or more wireless sensors, and receiving a second sensor data at a wrist worn apparatus associated with one or more wired sensors coupled to the wrist worn apparatus via a wired interface. The operations further include receiving a third sensor data at a wrist worn apparatus associated with one or more sensors disposed on the wrist worn apparatus, and operating the wrist worn apparatus responsive to the first sensor data, second sensor data, or third sensor data.

In one example embodiment, a bracelet forms a platform for sensors with attachable components. The bracelet contains a motion sensing device that can monitor the movement of the wrist for gestures. For example, the motion sensing device may be an InvenSense™ 9150 module capable of 9-axis motion tracking and including accelerometers, a gyroscope, and a compass. The bracelet also includes a wireless communication capability with a hub, like a PC, smartphone or possibly another clip on device which can communicate to the Internet to relay sensor data. In addition, the sensor bracelet has electrical attachments for one or more fingers. In particular, one finger can take a finger clip pulse sensor which looks like a single finger covering that hooks to the bracelet. The pulse sensor stays fixed on the finger and provides optimal medical-quality measurements and is comfortable. In effect, a glove with a single finger, such as a finger sock.

The finger clip can also or alternatively have a motion sensor as well at the tip. Up to four finger sensor covers can also be attached individually, or the design can be implemented as a complete or detachable glove. With all five fingers and wrist motion sensor, the glove can stream finger motion to a server. Virtual typing is possible with two gloves. With motion sensors in wrist and fingers, finger gestures can be deduced independent of the person's wrist orientation (horizontal or vertical). This lends itself to applications including real-time sign language interpretation as well as recognition of other types of gestures.

Advantageously, the wrist worn sensor hub is uniquely position to gather a variety of sensor data. In particular, the wrist worn sensor hub is ideally positioned to gather data from sensors disposed on a user hand and fingers. Furthermore, the wrist worn sensor hub is suited to advantageously operate as a go-between between sensors and a mobile computing device such as a smartphone. For example, the wrist worn sensor hub is easy to wear constantly and is easily accessible.

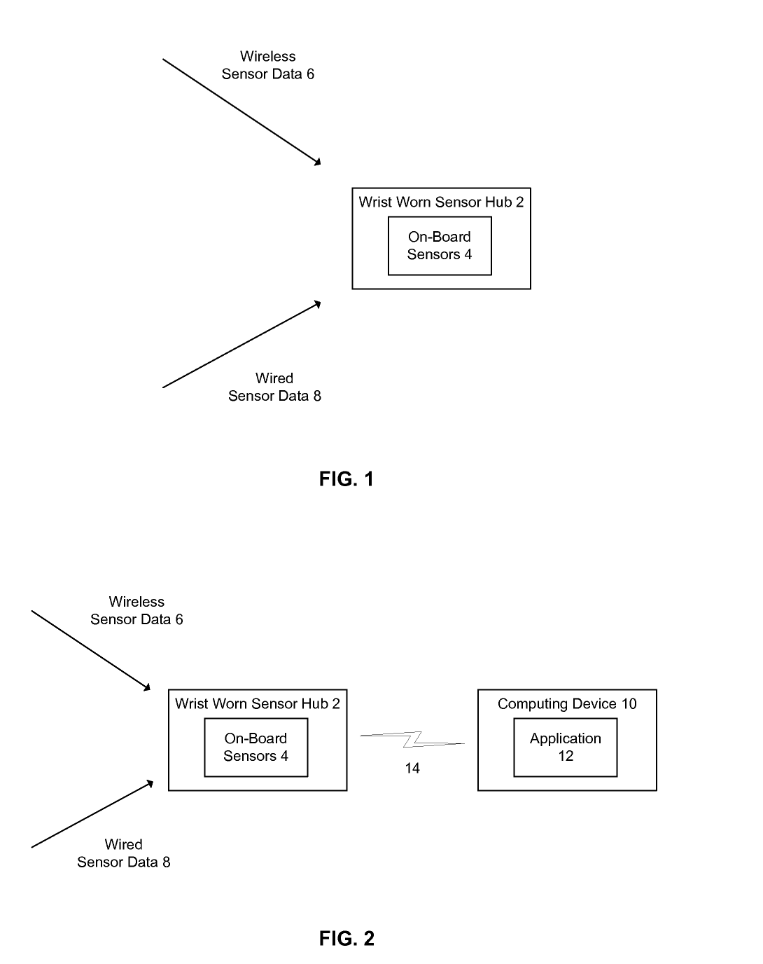

FIG. 1 illustrates a system for receiving sensor data at a wrist worn sensor hub 2 in one example. For example, the wrist worn sensor hub 2 may be in a bracelet form-factor or a wrist-watch type form-factor. In one example, the wrist worn sensor hub 2 includes a wireless communications interface configured to receive a wireless sensor data 6 from one or more wireless sensors and a wired communications interface configured to receive a wired sensor data 8 from one or more wired sensors. The wrist worn sensor hub 2 includes one or more onboard sensors 4 disposed on the wrist worn sensor hub 2 configured to output onboard sensor data. The wrist worn sensor hub 2 further includes a user interface, a processor, and a memory including an application to receive the wireless sensor data 6, the wired sensor data 8, and the onboard sensor data. In one example, the one or more onboard sensors 4 may include an ambient light sensor, a pulse sensor, a capacitive sensor, a pressure sensor, a motion sensor, a conductivity sensor, a skin temperature sensor, or a humidity sensor.

In one example, the wrist worn sensor hub 2 includes an I2C (or I²C) data bus configured to receive the wireless sensor data 6, wired sensor data 8, or onboard sensor data. In one example, the wired sensor data 8 includes motion data associated with a first user finger, second user finger, third user finger, fourth user finger and fifth user finger. For purposes herein, the user thumb is considered to be a user finger. In a further example, a serial peripheral interface (SPI) data bus may be utilized.

In one example, the application is configured to process the onboard sensor data to detect whether the wrist worn sensor hub 2 is worn or not worn on a user wrist. This worn/not worn sensor may be disposed on a bracelet connector clasp, for example, and can be a capacitive sensor, a physical switch, magnetic switch, or a conductivity switch.

In one example, the wireless sensor data 6, wired sensor data 8, or onboard sensor data is capable of being processed to detect a user wrist or forearm orientation. For example, the wrist worn sensor hub 2 can determine whether the user wrist or forearm orientation is along an x-axis direction, y-axis direction, or z-axis direction, where the x-axis is across the user body (i.e., from left to right), the y-axis is away from the user body (i.e., from front to back), and the z-axis is perpendicular to the ground (i.e., from toe to head). The wrist worn sensor hub 2 is also operable to determine whether the forearm ventral side is facing the user or the forearm dorsal side is facing the user.

In one example, the wrist worn sensor hub 2 also includes a switch configured for one handed operation coupled to the wired communications interface or wireless communications interface, where the switch is configured to be worn on a user finger and operated by a user finger. For example, the switch may be a thumb switch such as a Mycestro™ 3D mouse device.

In one example, the application is configured to activate or deactivate one or more wrist worn sensor hub 2 components responsive to the wireless sensor data 6, wired sensor data 8, or onboard sensor data. For example, a microphone or speaker on the wrist worn sensor hub 2 may be activated or deactivated based on the user wrist or forearm orientation.

In one example, the wireless sensor data 6 or wired sensor data 8 are received from one or more sensors disposed in the fingers of a user-wearable glove and/or on the palm or top side of the glove. In one example, the wireless sensor data 6 or wired sensor data 8 includes a hand sensor data associated with a user hand. In one example, the application is configured to process the wireless sensor data 6, wired sensor data 8, or onboard sensor data to determine a finger motion relative to a user hand or user wrist motion or position.

In one example operation, the wrist worn sensor hub 2 receives a wireless sensor data 6 associated with one or more wireless sensors, and receives a wired sensor data 8 associated with one or more wired sensors coupled to the wrist worn sensor hub 2 via a wired interface. The wrist worn sensor hub 2 further receives onboard sensor data associated with one or more sensors 4 disposed on the wrist worn sensor hub 2. The wrist worn sensor hub 2 is operated responsive to the wireless sensor data 6, wired sensor data 8, or onboard sensor data. The wireless sensor data 6 may be received, for example, over a Bluetooth communications interface or a near field communications (NFC) interface.

FIG. 2 illustrates a system for utilizing sensor data received at a wrist worn sensor hub in one example. In the system shown in FIG. 2, wrist worn sensor hub 2 is in wireless communication with a computing device 10 via wireless communications link 14. Computing device 10 executes an application 12. For example, computing device 10 may be a smartphone, laptop computer, or personal computer.

In operation, wrist worn sensor hub 2 receives sensor data as described above in reference to FIG. 1. Wrist worn sensor hub 2 transmits the sensor data to computing device 10. Computing device 10 may advantageously offer greater processing power and/or a better user interface (e.g., display) than wrist worn sensor hub 2 and may execute a variety of applications to make use of the received sensor data. In one example, the computing device 10 processes the sensor data to identify a user action, and performs an action at the application 12 responsive to the user action. For example, the sensor data may be motion, position, or orientation data associated with a user finger, hand and/or wrist. For example, the computing device 10 may process the sensor data to a finger motion relative to a user hand or user wrist motion or position, or determine a user finger motion relative to other fingers. In a further example, the computing device 10 may process the sensor data to detect a user wrist or forearm orientation. In one example, sensor data is constantly being transmitted from the wrist worn sensor hub 2 to the computing device 10 for processing.

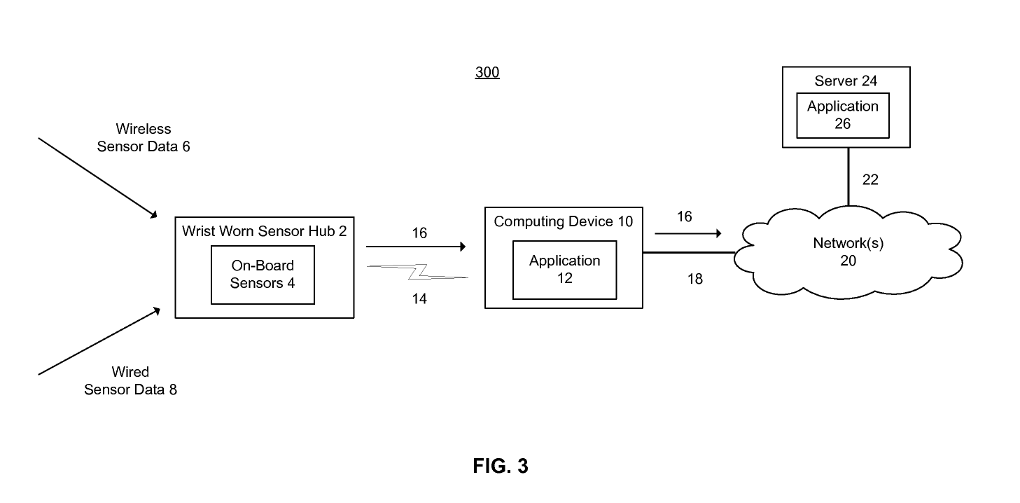

FIG. 3 illustrates an example implementation 300 of the system shown in FIG. 2, showing the flow of sensor data in one example. In implementation 300, computing device 10 is capable of communications with one or more communication network(s) 20 over network connection 18. A server 24 is capable of communications with one or more communication network(s) 20 over network connection 22. For example, communication network(s) 20 may include an Internet Protocol (IP) network, cellular communications network, public switched telephone network, IEEE 802.11 wireless network, or any combination thereof. Network connection 18 may be either wired or wireless network connections. Server 24 can be a server on the local network, or a virtual server in the cloud.

Wrist worn sensor hub 2 is capable of communications with computing device 10 over a wireless link 14. In operation, sensor data 16 from wrist worn sensor hub 2 is sent to computing device 10.

In one implementation, an application 12 executing on computing device 10 collects sensor data 16 and transmits it to an application 26 executing on server 24, which processes and responsively acts upon the sensor data 16. For example, the sensor data 16 may include wireless sensor data 6, wired sensor data 8, or sensor data from on-board sensors 4. In one implementation, computing device 10 operates as a relay, and any electronic device that subscribes to the computing device 10 can receive all sensor data 16.

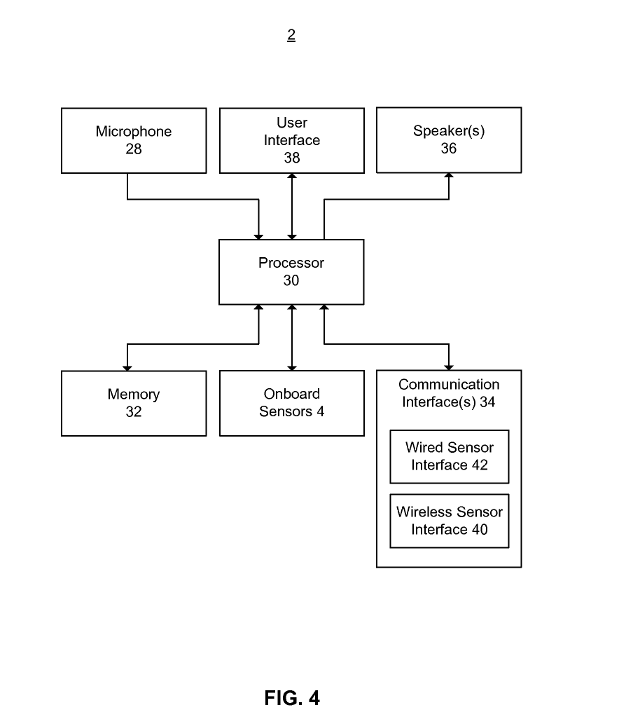

FIG. 4 illustrates a simplified block diagram of the wrist worn sensor hub 2 shown in FIG. 1 configured to implement one or more of the examples described herein. Examples of wrist worn sensor hub 2 include bracelets, wrist-watches, wristbands, etc. The term “wrist worn sensor hub” as used herein encompasses any wrist-worn device operable as described herein.

In one example, a wrist worn sensor hub 2 includes a microphone 28, user interface 38, speaker 36, a memory 32, and a communication interface(s) 34. Wrist worn sensor hub 2 includes a digital-to-analog converter (D/A) coupled to speaker 36 and an analog-to-digital converter (A/D) coupled to microphone 28. Microphone 28 detects sound and outputs a sound signal. In one example, the communication interface(s) 34 is a wireless transceiver and a wired network interface. User interface 38 may include various means to receive user actions to operate the wrist worn sensor hub 2, such as buttons or keys, or capacitive touch sensors. Input buttons may include for example on/off buttons or arrow keys. The user interface 38 may also include one or more output interfaces, such as LED indicators or some form of a display. The speaker 36 may also be used as an interface output.

Wrist worn sensor hub 2 may include one or more onboard sensors 4. For example, the onboard sensors 4 may include an ambient light sensor, a pulse sensor, a capacitive sensor, a pressure sensor, a motion sensor, a conductivity sensor, a skin temperature sensor, and a humidity sensor. The wireless sensors or wired sensors transmitting data to the wrist worn sensor hub 2 via wireless sensor interface 40 and wired sensor interface 42 may for example without limitation be one or more of these types of sensors.

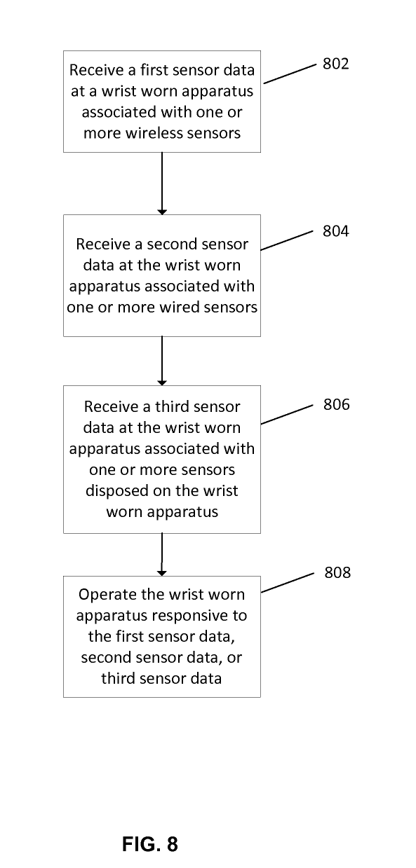

Memory 32 represents an article that is computer readable. For example, memory 32 may be any one or more of the following: random access memory (RAM), read only memory (ROM), flash memory, or any other type of article that includes a medium readable by processor 30. Memory 32 can store computer readable instructions for performing the execution of the various method embodiments of the present invention. In one example, the processor executable computer readable instructions are configured to perform part or all of a process such as that shown in FIGS. 8-10. Computer readable instructions may be loaded in memory 32 for execution by processor 30.

Communication interface(s) 34 allows wrist worn sensor hub 2 to communicate with other devices. Communication interface(s) 34 include a wired connection and a wireless connection. Communication interface(s) 34 may include, but are not limited to, a wireless transceiver, an integrated network interface, a radio frequency transmitter/receiver, a USB connection, or other interfaces for connecting wrist worn sensor hub 2 to a telecommunications network such as a Bluetooth network, cellular network, the PSTN, or an IP network. Communication interface(s) 34 include a wireless sensor interface 40. For example, wireless sensor interface 40 may be any wireless communication interface, including one or more short-range wireless communication subsystems. The short-range communications subsystem may include an infrared device and associated circuit components for short-range communication, a near field communications (NFC) subsystem, a Bluetooth subsystem including a transceiver, or an IEEE 802.11 (WiFi) subsystem in various non-limiting examples. Communication interface(s) include a wired sensor interface 42. In one example, wired sensor interface 42 is an I2C interface, which supports multiple parallel devices.

In one example operation, the wrist worn sensor hub 2 includes a processor 30 configured to execute one or more applications and operate the wrist worn sensor hub 2 to receive, collect, process, or transmit sensor data. In one example, the processor 30 is further configured to detect whether the wrist worn apparatus 3 is worn or not worn on a user wrist.

In one example, the one or more applications are configured to detect a user wrist or forearm orientation. For example, the user wrist or forearm orientation is along an x-axis direction, y-axis direction, or z-axis direction. In a further example, the user wrist or forearm orientation is a forearm ventral side facing the user or a forearm dorsal side facing the user. In one example, the one or more applications are configured to process the sensor data to determine a finger motion relative to the user hand or user wrist motion or position. In one example, the one or more applications are configured to activate or deactivate one or more system components responsive to the sensor data. In one example, the one or more applications are configured to transmit the sensor data to a computer via the wireless communications interface.

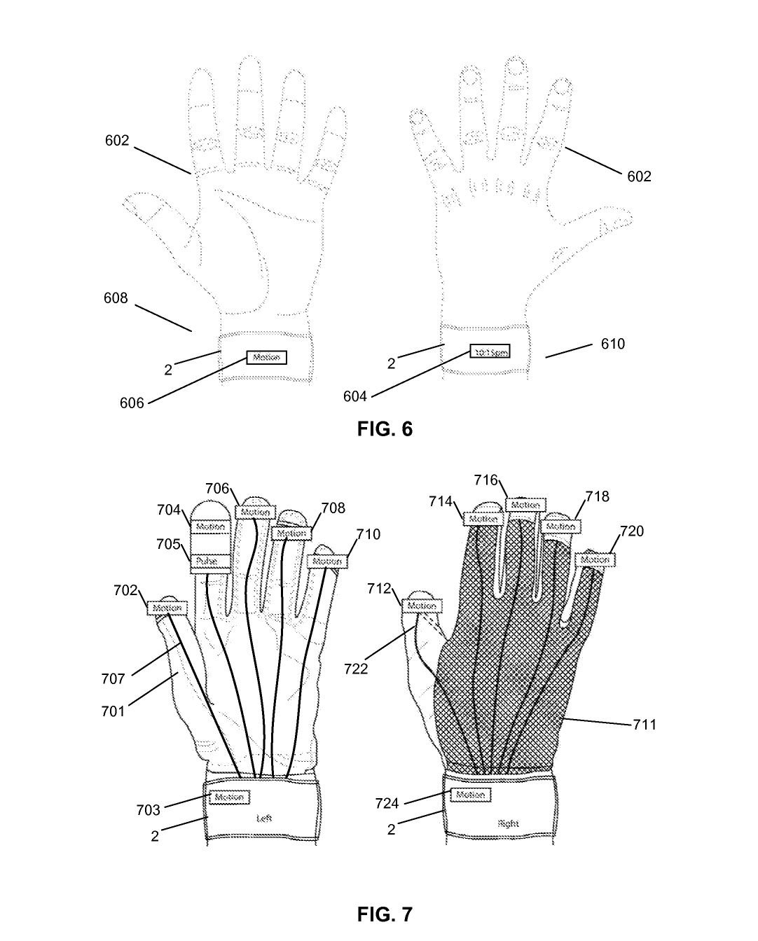

FIG. 6 illustrates the wrist worn sensor hub 2 shown in FIG. 1 worn on a user wrist. In this example, wrist worn sensor hub 2 includes a motion detector 606 as one of the on-board sensors 4 and a display 604. Illustrated in FIG. 6 is a user left hand 602 positioned so that the ventral side 608 of the user forearm and hand (palm up) is facing the user, and a user left hand positioned so that the dorsal side 610 of the user forearm and hand (palm down) is facing the user. In the example shown in FIG. 6, display 604 is visible to the user when the forearm and wrist dorsal side is facing the user.

FIG. 7 illustrates the wrist worn sensor hub 2 shown in FIG. 1 with a plurality of motion sensors coupled to the wrist worn sensor hub using a wired interface. In this example, a wrist worn sensor hub 2 and a plurality of attached wired sensors are shown integrated with a left glove 701. Wrist worn sensor hub 2 is disposed at the base of left glove 701, and includes a motion sensor 703. Wrist worn sensor hub 2 includes a motion sensor 702 coupled via a wire connector 707, where the motion sensor 702 is disposed in the thumb of left glove 701. Similarly, wrist worn sensor hub 2 includes motion sensors 704, 706, 708, and 710 coupled via wire connectors, where motion sensors 704, 706, 708, and 710 are disposed in the left hand index finger, middle finger, ring finger, and pinky finger, respectively.

In one example, a pulse monitoring sensor 705 may also be coupled via a wire connector to wrist worn sensor hub 2. A hand sensor may be disposed on either or both the top of the hand or on the palm of the glove in one embodiment. In one implementation, each sensor has an I2C interface, which advantageously supports parallel devices. It consists of an SCL (clock) line and an SDA (Data) line. Each sensor has a unique address. They would have their common power, ground, SCL and SDA lines connected. The sensors are anchored in the glove to more or less keep close contact with the body part they are monitoring.

In the example shown in FIG. 7, a second wrist worn sensor hub 2 and a plurality of attached wired sensors are also shown integrated with a right glove 711. The wrist worn sensor hub 2 is disposed at the base of right glove 711, and includes a motion sensor 724. Wrist worn sensor hub 2 includes a motion sensor 712 coupled via a wire connector 722, where the motion sensor 712 is disposed in the thumb of right glove 711. Similarly, wrist worn sensor hub 2 includes motion sensors 714, 716, 718, and 720 coupled via wire connectors, where motion sensors 714, 716, 718, and 720 are disposed in the right hand index finger, middle finger, ring finger, and pinky finger, respectively. A hand sensor may be disposed on either or both the top of the hand or on the palm of the glove in one embodiment.

In one example operation, each sensor is polled by a coprocessor for its current state (orientation, rotation rate, heading). For each instant in time at each hand, all 5 finger sensors are polled as well as the hand sensor and wrist sensor. A stick model of the fingers, hand and wrist can be made in software (e.g., executing on a mobile device or PC) using the information polled from the coprocessor. For example, in a piano or typing application, knowing the wrist and hand orientation provides detail as to how the fingers are oriented with respect to the wrist. This is utilized to determine if the keys are being touched or not. For example, the user finger may go from horizontal to vertical, but if the hand and wrist are not horizontal, it is not known for certain. Furthermore, if the user is doing the motion in the air, the sensor data is utilized to detect the relative motion of the fingers with respect to the hand and wrist to determine whether a key was touched.

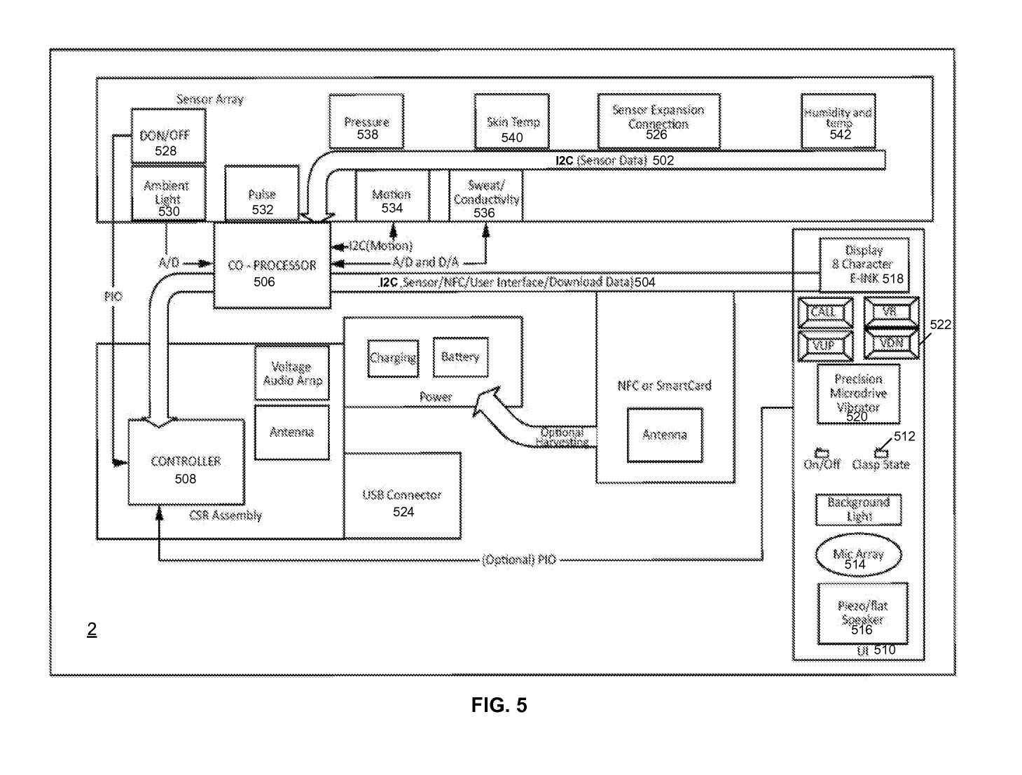

FIG. 5 illustrates a simplified block diagram of the wrist worn sensor hub 2 shown in FIG. 1 in a further example. In the example shown in FIG. 5, wrist worn sensor hub 2 includes a sensor expansion connection port 526. For example, sensor expansion connection port 526 is an I2C port allowing multiple wired I2C sensors to connect simultaneously in parallel to wrist worn sensor hub 2. Data received at the I2C port is placed on I2C Bus 502. I2C Bus 502 may also receive sensor data from one or more wireless sensors and onboard sensors, such as Don/Doff (i.e., worn/not worn) sensor 528 (e.g., a capacitive touch sensor), ambient light sensor 530, pulse sensor 532, motion sensor 534, sweat/conductivity sensor 536, pressure sensor 538, skin temperature sensor 540, and humidity and temperature sensor 542.

Data from one or more of the sensors may also be input to coprocessor 506 via a different I2C bus or directly without the use of a data bus. The data from I2C bus 502 is input to coprocessor 506. In turn, coprocessor 506 outputs data to controller 508. The data from one or more sensors may also be provided directly to controller 508. Controller 508 may also receive input via one or more programmed input outputs (PIOs). Wrist-worn sensor hub 2 includes a USB connector 524. In one example, controller 508 is implemented at a Bluetooth module capable of Bluetooth Low Energy (BLE) wireless communication with one or more wireless sensors to receive sensor data. In one example, sweat/conductivity sensor 536 is utilized to determine whether the wrist worn sensor hub 2 is being worn, such as if sweat/conductivity is detected.

Coprocessor 506 is also coupled to an I2C bus 504, which carries sensor data, near field communications (NFC) data, user interface data, and download data. Wrist-worn sensor hub 2 includes a user interface 510. User interface 510 may include a display device 518, vibrate motor 520, one or more input buttons 522, and clasp state detector 512 (e.g., mechanical switch or touch sense) operable to detect whether the wrist-worn bracelet is in a clasped state (i.e., the wrist worn sensor hub is being worn on the user wrist). User interface 510 may also include a microphone array 514 and speaker 516.

FIG. 8 is a flow diagram illustrating receiving sensor data received at a wrist-worn apparatus in one example. At block 802, a first sensor data is received at a wrist worn apparatus associated with one or more wireless sensors. In one example, the first sensor is data is received over a Bluetooth communications interface and a near field communications interface.

At block 804, a second sensor data is received at a wrist worn apparatus associated with one or more wired sensors coupled to the wrist worn apparatus via a wired interface. In one example, the second sensor data comprises motion data associated with a movement of each finger of the user hand. In one example, the first sensor data or second sensor data comprises a hand sensor data associated with a user hand.

At block 806, a third sensor data is received at a wrist worn apparatus associated with one or more sensors disposed on the wrist worn apparatus. In one example, the one or more sensors disposed on the wrist worn apparatus comprise an ambient light sensor, a pulse sensor, a capacitive sensor, a pressure sensor, a motion sensor, a conductivity sensor, a skin temperature sensor, and a humidity sensor. In one example, the third sensor data is operable to be processed to detect whether the wrist worn apparatus is worn or not worn on a user wrist. In one example, the third sensor data is operable to be processed to detect a user wrist or forearm orientation. For example, the user wrist or forearm orientation is along an x-axis direction, y-axis direction, or z-axis direction. In a further example, the user wrist or forearm orientation is a forearm ventral side facing the user or a forearm dorsal side facing the user. In one example, the first sensor data, second sensor data, or third sensor data is processed to determine a finger motion relative to the user hand or user wrist motion or position.

At block 808, the wrist worn apparatus is operated responsive to the first sensor data, second sensor data, or third sensor data. In one example, operating the wrist worn apparatus responsive to the first sensor data, second sensor data, or third sensor data comprises activating or deactivating one or more wrist worn apparatus components responsive to the sensor data. For example, the microphone may be activated or deactivated based on the user wrist or forearm orientation. In one example, the operations include transmitting the first sensor data, the second sensor data, or third sensor data to a computer via a wireless communications interface.

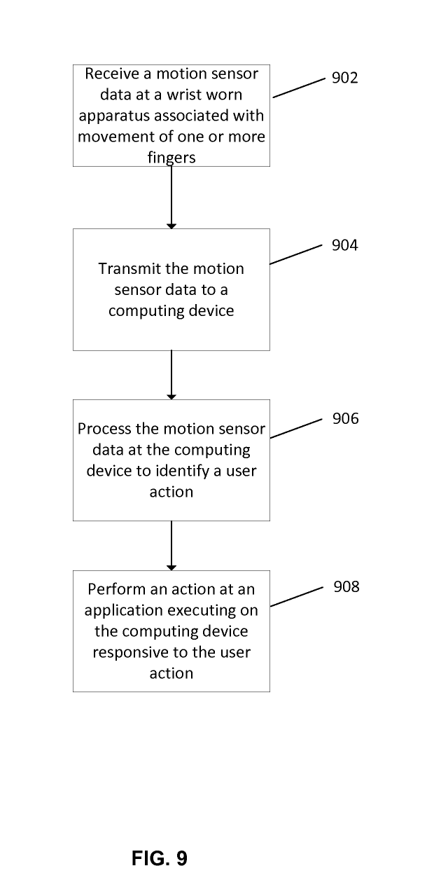

FIG. 9 is a flow diagram illustrating utilizing sensor data received at a wrist-worn apparatus in one example. At block 902, a motion sensor data is received at a wrist worn apparatus associated with movement of one or more user fingers. In one example, the motion sensor data is received at the wrist worn apparatus via a wired communications interface. In one example, receiving a motion data includes receiving a first motion data associated with movement of a first user finger, receiving a first motion data associated with movement of a first user finger, receiving a second motion data associated with movement of a second user finger, receiving a third motion data associated with movement of a third user finger, receiving a fourth motion data associated with movement of a fourth user finger, and receiving a fifth motion data associated with movement of a fifth user finger. In one example, the motion sensor data is associated with a plurality of motion sensors disposed in the fingers of a user-wearable glove.

At block 904, the motion sensor data is transmitted to a computing device. At block 906, the motion sensor data is processed at the computing device to identify a user action. At block 908, an action is performed at an application executing on the computing device responsive to the user action. In one example, the operations further include receiving a sensor data operable to detect a user wrist or forearm orientation. For example, the user wrist or forearm orientation is along an x-axis direction, y-axis direction, or z-axis direction. In one example, the operations further receiving a switch data indicating a user depression of a switch.

In one example, the operations further include receiving a sensor data operable to detect a user wrist or forearm orientation, and where processing the motion sensor data at the computing device includes determining a finger motion relative to a user hand or user wrist motion or position. In one example, the operations further include receiving a sensor data disposed on a user hand.

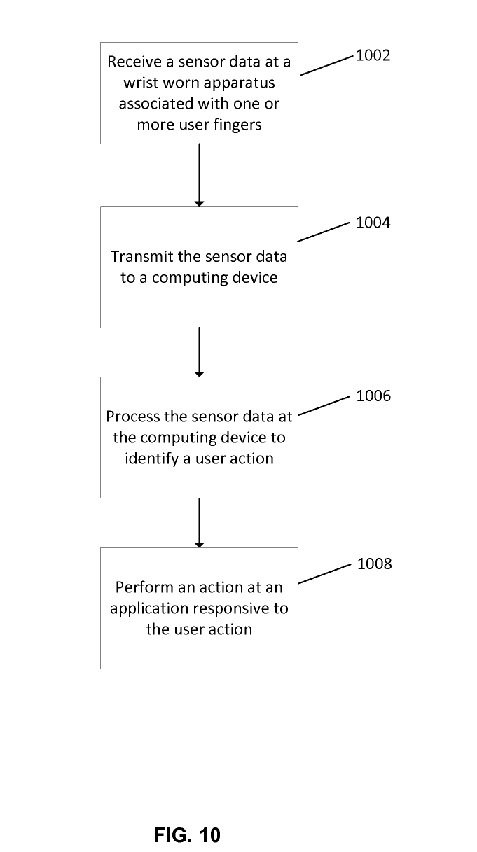

FIG. 10 is a flow diagram illustrating utilizing sensor data received at a wrist-worn apparatus in a further example. At block 1002, a sensor data is received at a wrist worn apparatus associated one or more user fingers. At block 1004, the sensor data is transmitted to a computing device. At block 1006, the sensor data is processed at the computing device to identify a user action. At block 1008, an action is performed at an application executing on the computing device responsive to the user action.

While the exemplary embodiments of the present invention are described and illustrated herein, it will be appreciated that they are merely illustrative and that modifications can be made to these embodiments without departing from the spirit and scope of the invention. Certain examples described utilize headsets which are particularly advantageous for the reasons described herein. In further examples, other devices, such as other body worn devices may be used in place of headsets, including wrist-worn devices. Acts described herein may be computer readable and executable instructions that can be implemented by one or more processors and stored on a computer readable memory or articles. The computer readable and executable instructions may include, for example, application programs, program modules, routines and subroutines, a thread of execution, and the like. In some instances, not all acts may be required to be implemented in a methodology described herein.

Terms such as “component”, “module”, “circuit”, and “system” are intended to encompass software, hardware, or a combination of software and hardware. For example, a system or component may be a process, a process executing on a processor, or a processor. Furthermore, a functionality, component or system may be localized on a single device or distributed across several devices. The described subject matter may be implemented as an apparatus, a method, or article of manufacture using standard programming or engineering techniques to produce software, firmware, hardware, or any combination thereof to control one or more computing devices.

Thus, the scope of the invention is intended to be defined only in terms of the following claims as may be amended, with each claim being expressly incorporated into this Description of Specific Embodiments as an embodiment of the invention.

What is claimed is:

1. A sensor system comprising:
a wrist worn apparatus comprising:
a wireless communications interface;
a wired communications interface;
a plurality of sensors;
a user interface;
a processor;
a memory comprising an application to receive a sensor data; and
a plurality of motion sensors coupled to the wired communications interface, wherein each motion sensor of the plurality of motion sensors is configured to be worn on a user finger.

2. The sensor system of claim 1, further comprising one or more wireless sensors configured to transmit a wireless sensor data to the wireless communications interface.

3. The sensor system of claim 1, wherein a sensor of the plurality of sensors is configured to detect a user wrist or forearm orientation.

4. The sensor system of claim 3, wherein the user wrist or forearm orientation is along an x-axis direction, y-axis direction, or z-axis direction.

5. The sensor system of claim 3, wherein the user wrist or forearm orientation is a forearm ventral side facing the user or a forearm dorsal side facing the user.

6. The sensor system of claim 1, further comprising a switch configured for one handed operation coupled to the wired communications interface, wherein the switch is configured to be worn on a user finger and operated by a user finger.

7. The sensor system of claim 1, wherein the application is configured to process the sensor data to determine a finger motion relative to a user hand or user wrist motion or position.

8. The sensor system of claim 1, wherein the application is configured to transmit the sensor data to a computer via the wireless communications interface.

9. A wrist worn sensor hub comprising:
a wireless communications interface configured to receive a first sensor data from one or more wireless sensors;
a wired communications interface configured to receive a second sensor data from one or more wired sensors;
one or more onboard sensors disposed on the wrist worn sensor hub configured to output a third sensor data;
a user interface;
a processor; and
a memory comprising an application to receive the first sensor data, the second sensor data, and the third sensor data.

10. The wrist worn sensor hub of claim 9, further comprising an I2C data bus configured to receive the first sensor data, second sensor data, or third sensor data.

11. The wrist worn sensor hub of claim 9, wherein the second sensor data comprises motion data associated with a first user finger, second user finger, third user finger, fourth user finger and fifth user finger.

12. The wrist worn sensor hub of claim 9, wherein the application is configured to process the third sensor data to detect whether the wrist worn sensor hub is worn or not worn on a user wrist.

13. The wrist worn sensor hub of claim 9, wherein the one or more onboard sensors comprise an ambient light sensor, a pulse sensor, a capacitive sensor, a pressure sensor, a motion sensor, a conductivity sensor, a skin temperature sensor, or a humidity sensor.

14. The wrist worn sensor hub of claim 9, wherein the first sensor data, second sensor data, or third sensor data is capable of being processed to detect a user wrist or forearm orientation.

15. The wrist worn sensor hub of claim 9, wherein the user interface comprises: a microphone and a speaker.

16. The wrist worn sensor hub of claim 9, wherein the application is configured to activate or deactivate one or more wrist worn sensor hub components responsive to the first sensor data, second sensor data, or third sensor data.

17. The wrist worn sensor hub of claim 9, wherein the one or more wired sensors or one or more wireless sensors are disposed in the fingers of a user-wearable glove.

18. The wrist worn sensor hub of claim 9, wherein the one or more wired sensors or one or more wireless sensors comprise a hand sensor configured to be worn on a user hand.

19. The wrist worn sensor hub of claim 9, wherein the application is configured to process the first sensor data, second sensor data, or third sensor data to determine a finger motion relative to a user hand or user wrist motion or position.

20. One or more non-transitory computer-readable storage media having computer-executable instructions stored thereon which, when executed by one or more computers, cause the one more computers to perform operations comprising:
receiving a motion sensor data at a wrist worn apparatus associated with movement of one or more user fingers;
transmitting the motion sensor data to a computing device;
processing the motion sensor data at the computing device to identify a user action; and
performing an action at an application executing on the computing device responsive to the user action.

21. The one or more non-transitory computer-readable storage media of claim 20, wherein the motion sensor data is received at the wrist worn apparatus via a wired communications interface.

22. The one or more non-transitory computer-readable storage media of claim 20, wherein the operations further comprise receiving a sensor data operable to detect a user wrist or forearm orientation.

23. The one or more non-transitory computer-readable storage media of claim 20, wherein receiving a motion data comprises receiving a first motion data associated with movement of a first user finger, receiving a first motion data associated with movement of a first user finger, receiving a second motion data associated with movement of a second user finger, receiving a third motion data associated with movement of a third user finger, receiving a fourth motion data associated with movement of a fourth user finger, and receiving a fifth motion data associated with movement of a fifth user finger.

24. The one or more non-transitory computer-readable storage media of claim 20, wherein the operations further comprise receiving a sensor data operable to detect a user wrist or forearm orientation, and wherein processing the motion sensor data at the computing device comprises determining a finger motion relative to a user hand or user wrist motion or position.
